(19) United States
(12) Patent Application Publication
(10) Pub. No.: US 2006/0141111 A1
(43) Pub. Date: Jun. 29, 2006

(54) Process to sanitize fruit and vegetables

(76) Inventor: William Bliss, Pakenham (AU)

Correspondence Address: EDWIN D. SCHINDLER, FIVE HIRSCH AVENUE, P.O. BOX 966, CORAM, NY, 11727-0966, US

(21) Appl. No.: 10/546,338

(22) PCT Filed: Feb. 20, 2004
(86) PCT No.: PCT/AU04/00212

§ 371 Date: Aug. 18, 2005

(30) Foreign Application Priority Data
Feb. 21, 2003 (AU) 2003900788
Mar. 19, 2003 (AU) 2003901274

(51) Int. Cl. A23L 3/3463

(52) U.S. Cl. 426/335

(57) ABSTRACT

A process to sanitize fruit and vegetables, which may be used for products that are whole, diced, sliced, peeled, chopped or shredded. The process includes the use of a disinfectant agent, such as, for example, BCDMH, at a pH at, or above, 8.3. A buffer is used to obtain the correct pH and is, preferably, a mixture of calcium, sodium and potassium salts.

### TECHNICAL AREA

The invention relates to the area of disinfection processes and in particular, to a process to sanitize fruit and vegetables which may be used for products that are whole, diced, sliced, peeled, chopped or shredded.

While the invention relates to process which can be used on any fruit or vegetable, for convenience sake it will be discussed herein in terms of being used to sanitize chopped parsley which, is recognised in the industry as being extremely difficult to clean.

### BACKGROUND TO THE INVENTION

The use of halogen disinfectants to control pathogens in water, is one which is well known and has been around for many years. For example, drinking water may be controlled by halogen disinfectants, with residuals of 0.1 to 2ppm (as chlorine) being commonly detected in reticulated supplies of drinking water.

Fruit and vegetables are common targets for a variety of human pathogens which may be found on the surface of the product and as such, are required to be sanitized.

Many fruit and vegetables will often also have a bio-film layer which can act as a protective coating for the pathogen, thus complicating the removal of the pathogens. The bio-film may also react with, and consequently de-activate, the disinfecting chemicals.

In order to overcome this problem, it has previously been commercial practice to use chlorine products such as sodium hypochlorite and calcium hypochlorite, at rates of 50 to 200 parts per million (as chlorine) in an endeavour to remove the pathogens. However, the use of such high levels of chlorine products can lead to a number of problems such as:
1. Chloramines, which irritate the workers when the material is being treated;
2. Corrosion of chillers and metal fittings by the free chlorine in the water;
3. The necessity to add acid to reduce the pH to 7.5;
4. The cost of the mixture used;
5. The disposal of the wash solution, as the EPA limit the passing of waste of wash solutions which have greater than 1.0 ppm (as chlorine); and
6. The operating range is outside the normal operating range of ORP controllers.

In the late 1970s Warren & Ridgeway compared the use of chlorine with SDIC (Sodium DichlorolsoCyanurate) and TICA (Trichloro Iso Cyanuric Acid) and reported an apparent difference in activity against staphylococcus aureus when the three were used at the same rate.

TICA was suggested by these workers to be a more effective agent than chlorine as, once it had penetrated the cell wall as TICA, it had the capacity to form hypochlorous acid inside the cell.

In 1999 Taverner & Cunningham compared Calcium Hypochlorite, SDIC, TICA and BCDMH (Bromo Chloro Dimethyl Hydantoin) against geotrichium sp. on the surface of citrus fruits. The results revealed BCDMH to be very effective in comparison to the other products.

### OUTLINE OF THE INVENTION

It is an object of the present invention to overcome or substantially ameliorate the problems of the prior art by providing a process to sanitize fruit and vegetables in a wash process.

The invention provides, in the treatment of fruit and vegetables, a process to sanitize fruit and vegetables including the use of a disinfectant agent and a buffer.

It is preferred that the disinfectant agent be BCDMH.

It is preferred that the BCDMH be used at a pH at or above 8.3.

It is further preferred that the required pH may be obtained through the use of a buffer.

It is preferred that the buffer composition be made of a mixture of calcium, sodium and potassium salts.

It is further preferred that the buffer can consist of a solution of:
Sodium bicarbonate (NaHCO₃);
Borax (Na₂B₄O₇10H₂O);
Sodium sesquicarbonate (Na₂CO₃Na HCO₃2H₂O); and
Sodium carbonate (Na₂CO₃).

In order that the invention be more readily understood we will describe by way of a non-limiting example a specific embodiment of the invention as an exemplification and which, will be sufficient to give those skilled in the art an indication of the application of the method which can then be applied to other fruit and vegetables.

### DESCRIPTION OF AN EMBODIMENT OF THE INVENTION

In this embodiment of the invention, the BCDMH is administered with an erosion feeder, with the levels of disinfectant being controlled by a redox probe controller operating between 200 to 1000 mv to give levels of chlorination between 10 to 30 ppm (as chlorine). As an indication, if the same product was being treated with sodium hydrochlorite, this compound would be used at a rate of approximately 150 ppm (as chlorine).

The buffering agent in the wash solution can be a mixture of calcium, sodium and potassium salts as carbonate, bicarbonate, sesquicarbonate, phosphate and metasilicate, which are formulated to give a stable pH of 8.4 to 9.6 with a reserve alkalinity of between 120 to 240 ppm (as calcium carbonate).

The actual buffer compositions which may be used are:

| Active | Sodium bicarbonate NaHCO₃ | | |
|---|---|---|---|
| Concentration | 100 ppm | 1000 ppm | 10000 ppm |
| pH | 8.3 | 8.5 | 8.4 |
| Active | Borax Na₂B₄O₇10H₂O | | |
| Concentration | 100 ppm | 1000 ppm | 10000 ppm |
| pH | 9.1 | 9.1 | 9.2 |
| Active | Sodium sesquicarbonate Na₂CO₃NaHCO₃2H₂O | | |
| Concentration | 100 ppm | 1000 ppm | 10000 ppm |
| pH | 10.1 | 10.1 | 9.9 |
| Active | Sodium carbonate Na₂CO₃ | | |
| Concentration | 100 ppm | 1000 ppm | 10000 ppm |
| pH | 10.8 | 11.0 | 11.4 |

Each of the buffer mixtures are blended to get the appropriate stable pH. The alkalies in the buffer mixture react with some of the organic compounds to produce and improved surface cleaning action.

Whilst it is believed that the most effective disinfecting compound to be used is BCDMH, it is envisaged that any other suitable compound such as SDIC, TICA, DCDMH (DiChloro DiMethyl Hydantoin), DBDMH (DiBromo DiMethyl Hydatoin), BCTMH (Bromo Chloro Tetra Methyl Hydantoin), may be used.

To achieve an additional level of disinfection activity, it is possible to add TCDO (Tetra Chloro Decaoxide) to the mixture which operates by reacting with the chlorination products to produce chlorine dioxide ClO₂. Previous processes have incorporated sodium chlorite to the mixture in order the produce chlorine dioxide however, the resulting product is acidic in solution and contains some chlorite ion ClO₂⁻ which is a potential health hazard.

TCDO alternatively, is not pH dependent and does not produce the Chlorite ion ClO₂⁻ in the following reaction:
CI₄O₁₀+CI→4CIO₂+O₂↑+CI⁻.

Instead, the oxygen simply passes from the solution. TCDO not being pH dependent is quite advantageous in that, the activity of chlorine dioxide is also not pH dependent and thus, an effective product is still able to be obtained at a pH range of 8.4 to 9.6 which is the range at the process of the invention operates.

In the dosing of the chlorination disinfectant, a benefit is gained from the fact the water passing through the chemical feeder actually comes from the mains supply. By not using the wash water which may be contaminated with high levels of organic materials through the feeder, it is possible to avoid the formation of undesirable bi-products in situ.

We have found that the process of the invention using BCDMH at 20 ppm at pH 8.3 on chopped parsley, gives a greatly superior result to the more conventional methods involving the use of sodium hypochlorite at 150 ppm at pH 7.5. The use of the process of the invention also appears to give the superior results it does as the compound utilised are able to interact with the phospholipids of the cell membrane allowing penetration of the cytoplasm to give a greater sanitation effect.

Whilst we have described herein a specific embodiment of the invention, it is to be understood that other embodiments of the invention will exhibit any number of and any combination of the features previously described, and any and all such variations and modifications can be made in the invention without departing from the spirit and scope of the invention.

1-12. (canceled)

13. A process for sanitizing fruit and vegetables, comprising the steps of:
applying a disinfectant agent to fruits or vegetables to be sanitized; and,
using a buffer for controlling pH of the disinfectant agent.

14. The process for sanitizing fruit and vegetables according to claim 13, wherein said disinfectant agent is bromochlorodimethyl-hydantion (BCDMH).

15. The process for sanitizing fruit and vegetables according to claim 14, wherein said bromochlorodimethyl-hydantion is used at a pH of 8.3 or higher.

16. The process for sanitizing fruit and vegetables according to claim 15, wherein said step of using a buffer for controlling pH is performed for controlling the pH of said bromochlorodimethyl-hydantion.

17. The process for sanitizing fruit and vegetables according to claim 16, wherein said buffer for controlling the pH of said bromochlorodimethyl-hydantion comprises a mixture of calcium, sodium and potassium salts.

18. The process for sanitizing fruit and vegetables according to claim 16, wherein said buffer for controlling the pH of said bromochlorodimethyl-hydantion comprises a solution of:
sodium bicarbonate (NaHCO₃);
borax (Na₂B₄O₇10H₂O);
sodium sesquicarbonate (Na₂CO₃NaHCO₃2H₂O); and,
sodium carbonate (Na₂CO₃).

19. The process for sanitizing fruit and vegetables according to claim 13, wherein said disinfectant agent is a member selected from the group consisting of sodiumdichloro-cyanurate (SDIC), trichloro-isocyanuric acid (TICA), dichlorodimethyl-hydratoin (DCDMH), dibromodimethyl-hydantoin (DBDMH), bromochlorotetramethyl-hydantoin (BCTMH) and a combination thereof.

20. The process for sanitizing fruit and vegetables according to claim 19, wherein said step of using a buffer for controlling pH is performed for controlling the pH of said member of said group of said disinfectant agent.

21. The process for sanitizing fruit and vegetables according to claim 20, wherein said buffer for controlling the pH of said member of said group of said disinfectant agent comprises a mixture of calcium, sodium and potassium salts.

22. The process for sanitizing fruit and vegetables according to claim 21, wherein said buffer for controlling the pH of said member of said group of said disinfectant agent comprises a solution of:
sodium bicarbonate (NaHCO₃);
borax (Na₂B₄O₇10H₂O);
sodium sesquicarbonate (Na₂CO₃NaHCO₃2H₂O); and,
sodium carbonate (Na₂CO₃).

23. The process for sanitizing fruit and vegetables according to claim 13, wherein said process is a wash process.

24. The process for sanitizing fruit and vegetables according to claim 23, wherein said wash process uses a chemical feeder with water passing therethrough.

25. The process for sanitizing fruit and vegetables according to claim 24, wherein the water comes a mains supply.
